(19) United States
(12) Patent Application Publication
(10) Pub. No.: US 2023/0394546 A1
(43) Pub. Date: Dec. 7, 2023

(54) System and Method for Creating Personalized Life Events Digital Books

(71) Applicant: Luis Olivares, Jacksonville, FL (US)

(72) Inventor: Luis Olivares, Jacksonville, FL (US)

(21) Appl. No.: 18/147,020

(22) Filed: Dec. 28, 2022

Related U.S. Application Data
(60) Provisional application No. 63/349,216, filed on Jun. 6, 2022.

(51) Int. Cl. G06Q 30/0601

(52) U.S. Cl. CPC G06Q 30/0621

(57) ABSTRACT

The present invention relates to a system and method for creating a plurality of customizable digital books representing different life events, life of a deceased person, quotes, poems, and more. Contextually digital books are inter-inked using links enabling a user to navigate between the books. In some embodiments, quotes can be selected for providing as a reminder to a user, poems can be selected to form a plurality of poem books, information of a deceased person can be added to form a book about the deceased person which can be shared with a plurality of individuals, life story of a person can be added in the form of a plurality of volumes describing different stages of life and more. The invention offers a way for individuals to create electronic book volumes for different time periods in a user's life while maintaining them in a digital format.

### CROSS-REFERENCE TO RELATED APPLICATION

The present application claims priority to, and the benefit of, U.S. Provisional Application No. 63/349,216, which was filed on Jun. 6, 2022, and is incorporated herein by reference in its entirety.

### FIELD OF THE INVENTION

The present invention relates generally to the field of digital books. More specifically, the present invention relates to a novel system and method for creating digital books for recording life events, information of a deceased person, couple's story, quotes, poems, and more. The system includes a software application from which users can create, access, customize, and share their digital books. The books are interrelated and can be shared with family and friends. Accordingly, the present disclosure makes specific reference thereto. Nonetheless, it is to be appreciated that aspects of the present invention are also equally applicable to other like applications, devices, and methods of manufacture.

### BACKGROUND

By way of background, photo album books are used for preserving fond memories so that the memories are never forgotten. Reliving memories through photographs, books, and more is an activity that many individuals enjoy. However, physical albums, books, and more require space for storage and are difficult to maintain. Further, the physical books are prone to theft, loss, and damage. Further, since the arrival of the smartphone and digital picture frames, physical photo albums, and books have taken a back seat and are less preferred by individuals.

Many digital products are available in the market that enable individuals to digitally store images, videos, and more. However, such digital products and books do not provide an appearance and feel of physical books and albums. Further, many of such products are not customizable and may not enable a user to customize the template and cover pages of the books. Individuals desire improved digital books that enable customizations and personalization by a user.

Many digital products independently store different media without any connection and story therebetween. Such products do not provide an effective user experience and further, do not link different digital books based on their profile. Individuals may not be able to navigate between the contextually related books. Therefore, individuals desire an improved system that provides them the digital books that can be inter-linked based on their content.

There is a plurality of digital couples' diaries in the market, but they do not enable the couple to change or modify the diaries independently while providing one person a notification of the change and enabling the other person to respond. Therefore, couples who live far away desire an improved product that makes them feel loved and secured by their partner.

Therefore, there exists a long-felt need in the art for a system that enables individuals to create and customize digital books. There is also a long-felt need in the art for a system that enables individuals to securely store a plurality of digital books. Additionally, there is a long-felt need in the art for digital books system that interlinks the contextually similar books enabling a user to easily navigate between them. Moreover, there is a long-felt need in the art for digital books that can record information in any desired format for special memories and events like vacations, birthdays, graduations, and much more. Further, there is a long-felt need in the art for improved digital books that offer a way for individuals to create electronic book volumes for different time periods in a user's life. Furthermore, there is a long-felt need in the art for digital books that can capture relevant texts, videos, quotes, images, and more. Finally, there is a long-felt need in the art for a digital books system that enables users to create a plurality of different digital books that includes quotes, poems, life stories, and more, and those can be shared with other users.

The subject matter disclosed and claimed herein, in one embodiment thereof, comprises a system and method of creating and accessing a plurality of digital books. The method comprising the steps of receiving, by a computing device, a plurality of media for creating one or more digital books; processing, by the computing device, the received media to create one or more digital books; receiving, an image and/or text for customizing the front and back cover of the digital books; and creating a link for linking one of the digital books to another digital book wherein a user redirects from the one of the digital books to the another digital book upon clicking the link. The digital books can include a personal book, a couple's book, a life history book, a quotes collection, a deceased person book, and more. The system includes a server that provides user interface for enabling users to create and customize the digital books.

In this manner, the system and method for creating digital books of the present invention accomplish all of the forgoing objectives and provide users with a system that includes a software application for recording life events in the form of digital books that include videos, pictures, text, and more. The invention enables users to create multiple digital books for different life events, enabling users to access the events from an organized file system within the application, thereby eliminating use of physical books and overcoming the problems associated with the conventional digital books.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method of creating and accessing a plurality of digital books. The method comprising the steps of receiving, by a computing device, a plurality of media for creating a digital book; processing, by the computing device, the received media to create a digital book; receiving, an image and/or text for customizing the front and back cover of the digital book; and creating a link for linking the digital book to another digital book wherein a user redirects from the digital book to another digital book upon clicking the link.

In yet another embodiment, a method of creating a digital book is described. The method includes the steps of displaying a plurality of digital poems to a user; the plurality of poems are divided into different genres; receiving a selection of one or more poems or genres from the user; creating the digital book including the selected poems or poems of the selected genre; receiving a customization of at least one of back cover, front cover, title, and content of the digital book from the user.

In yet another embodiment, a method for creating a memory book of a deceased person is disclosed. The method includes the steps of choosing a template for the memory book; receiving information including media, text and more such as anecdote, funny story, act of kindness, and more about the deceased person; creating the memory book using the received information; providing access to one or more family members and friends to access and customize the memory book; and sending a reminder of the deceased birthday/death anniversary to the authorized family members and friends. In doing so, family members and friends will maintain the deceased alive through collective remembrance.

In yet another embodiment, a digital life story book of a baby is disclosed. The digital life story book includes a plurality of volumes, a first volume features information including, but not limited to, day of conception, first visit to the gynecologist, details of the pregnancy, first image and video of the sonogram, baby shower, and more; a second volume features details of first six months of the baby and the subsequent volumes are written by a parent or caretaker of the baby until the baby starts to access and include information in the book.

In yet another embodiment, a system for enabling users to create and access personalized digital books is disclosed. The system includes a server having a processor configured to provide an e-book module for enabling creation of digital books, an e-book content module for storing digital media and text, a user information module for storing users' information wherein the processor is configured to create one or more digital books by including the stored media and text.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of a personalized electronic books system of the present invention in accordance with the disclosed architecture;

FIG. 2 illustrates an exemplary user interface showing options provided to a user for accessing the software application to utilize the functionalities of the personalized electronic books system of the present invention in accordance with the disclosed architecture;

FIG. 3 illustrates another user interface of the software application showing different digital or electronic books accessible to a user in accordance with the disclosed architecture;

FIG. 4 illustrates a user interface for customizing a personal diary in accordance with the disclosed architecture;

FIG. 5 illustrates a user interface for “In memory of person” diary in accordance with the disclosed architecture;

FIG. 6 illustrates an exemplary family tree displayed by the software application in accordance with the disclosed architecture;

FIG. 7 illustrates a user interface showing different sections of the “The story of my life” book in accordance with the disclosed architecture;

FIG. 8 illustrates a user interface showing different genres of a book in accordance with the disclosed architecture;

FIG. 9 illustrates a flow diagram depicting a process of accessing digital or electronic books on the software application by a user in accordance with the disclosed architecture;

FIG. 10 illustrates a flow diagram depicting a process of creating and customizing a digital book by a user in accordance with the disclosed architecture; and

FIG. 11 illustrates an exemplary user device that is used for installing the software application of the present invention for communication with the server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that enables individuals to create and customize digital or electronic books. There is also a long-felt need in the art for a system that enables individuals to securely store a plurality of digital or electronic books. Additionally, there is a long-felt need in the art for a digital or electronic books system that interlinks the contextually similar books enabling a user to easily navigate between them. Moreover, there is a long-felt need in the art for digital or electronic books that can record information in any desired format for special memories and events like vacations, birthdays, graduations, and much more. Further, there is a long-felt need in the art for improved digital or electronic books that offer a way for individuals to create electronic book volumes for different time periods in a user's life. Furthermore, there is a long-felt need in the art for digital or electronic books that can catalog relevant texts, videos, quotes, images and more. Finally, there is a long-felt need in the art for a digital books system that enables users to create a plurality of different digital or electronic books that includes quotes, poems, life stories, and more and those can be shared with other users.

The present invention, in one exemplary embodiment, is a system for enabling users to create and access personalized digital or electronic books. The system includes a server having a processor configured to provide an e-book module for enabling creation of digital books, an e-book content module for storing digital media and text, a user information module for storing users' information wherein the processor is configured to create one or more digital books by including the stored media and text.

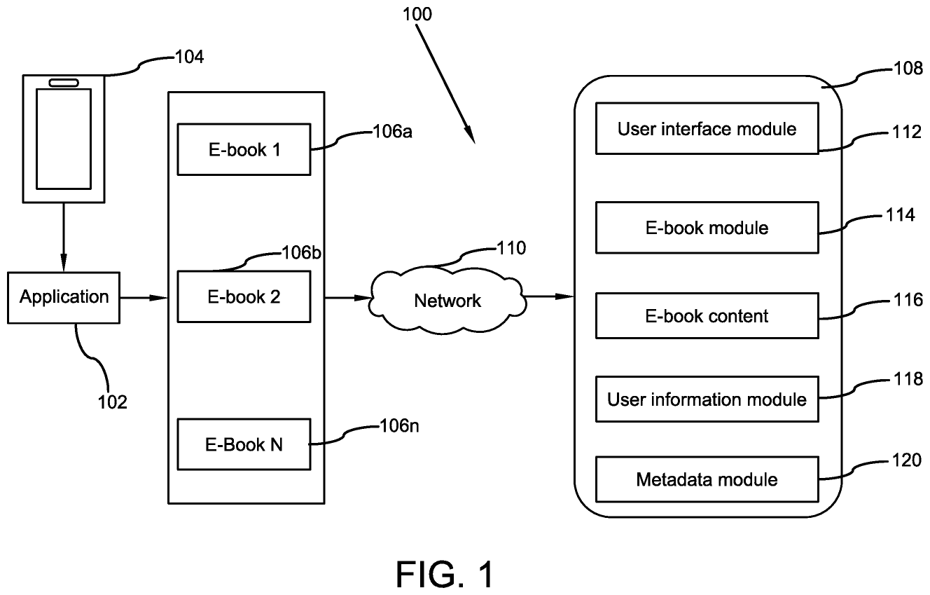

Referring initially to the drawings, FIG. 1 illustrates a schematic view of one potential embodiment of a personalized electronic books system of the present invention in accordance with the disclosed architecture. The personalized electronic books system 100 of the present embodiment is designed to provide a computer-implemented software application 102 accessed in a computing device 104 like a smartphone for creating and accessing a plurality of electronic books 106a-n corresponding to different life events. The system 100 enables users to record any event in any desired format to create electronic books in a digital format. A plurality of different types of digital books imitating physical books for including genealogy, stories of life, life of a deceased person, quotes, poems, and many more can be created and accessed by users.

The plurality of digital or electronic books 106a-n are stored locally in the application 102 or can also be stored in a remote server 108. The remote server 108 is accessible via the network 110 using the application 102. The server 108 includes a user interface module 112 configured to generate required user interfaces for creating and accessing digital or electronic books. The user interface module 112 enables the user interface to scale and conform to the size of display screen of the computing device 104. An e-book module 114 is configured to provide and modify the layout of a digital book enabling a user to create and access the digital books. The digital books formed by e-book module 114 may have a plurality of templates for accommodating different types of digital or electronic books offered by the digital books system 100. The e-book module 114 may provide textual portions, graphical portions, and provision of addition of different media as per preferences of the users.

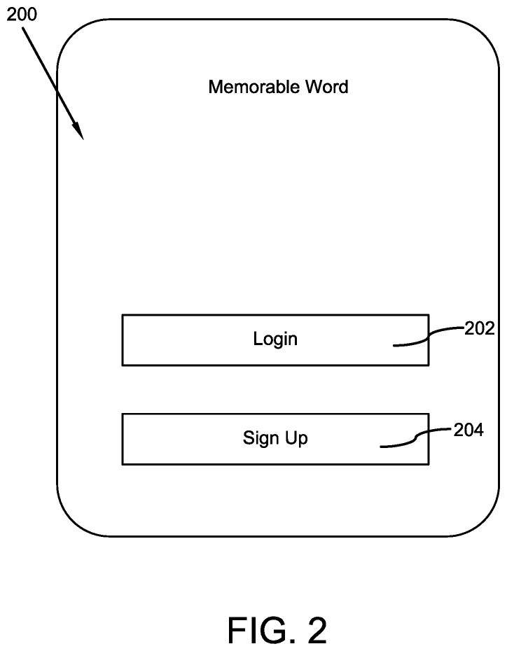

E-book content module 116 is configured to securely store the digital or electronic books of users. The digital books created by a user may be accessed only by authorized users, thereby preventing unauthorized access, and thus maintaining security and privacy. The content module 116 can include storage space in the form of a database for storing the digital books of the users. A user information module 118 is configured to store credentials, personal information, and payment information of users. For accessing the digital books by a user, the credentials input by the user (as illustrated in FIG. 2) are compared to the stored credentials by the user information module 118.

A metadata module 120 is configured to store metadata items such as publication date, timestamp, title, tags, comments, and more of digital books. The metadata module 120 enables the books to be searched and appropriate images, chapters, and more can be easily copied from one digital book to another. Each digital book has a sequence of chapters and each chapter may be associated with a metadata enabling the user to adjust, copy and/or change the chapter using the metadata.

In one exemplary embodiment, the user interface module 112 provides an editor for defining new content and for uploading new content and files that can be used for building the digital or electronic books. The user interface module 112 and the e-book module 114 can translate the uploaded documents and media into an appropriate format such as .XHTML for building a digital book. For creating and publishing the digital book, a cost or fee can be charged by the system 100 and a digital book or any of its portion can be made public for public access as per preferences of a user creating the digital book.

Any number of digital books to record important life events, upload important media, accommodate childhood, adulthood and more can be created by users. All the digital books 106 offered by the digital books system 100 have an appearance and feel of physical books such that the users can turn the pages of the books like those of a physical book by dragging a corner of a page of the book. Further, the individual books may have one or more links linked to other books of the user such that clicking on the link can enable the user to directly go to another book or a specific portion thereof.

The network 110 can include any wireless or wired channel associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

The server 108 is configured to have the logic, instructions, circuitry, interfaces, and/or codes for executing various operations required for communication between the server 108 and the application 102. Further, the servers 108 can include, but are not limited to, personal computers, laptops, mini-computers, mainframe computers, any non-transient and tangible machine that can execute a machine-readable code, cloud-based servers, distributed server networks, or a network of computer systems. The server 108 can be realized through various web-based technologies such as, but not limited to, a Java web-framework, a .NET framework, a personal home page (PHP) framework, or any web-application framework.

FIG. 2 illustrates an exemplary user interface showing options provided to a user for accessing the software application to utilize the functionalities of the personalized electronic books system of the present invention in accordance with the disclosed architecture. The exemplary user interface 200 provides a login option 202 enabling a user to use credentials including username and password for accessing different digital or electronic books created by the user. Different user interfaces are provided for accessing different books and creation of books by the user.

A sign-up option 204 is configured to enable a user to fill personal information and create a profile for accessing functionalities provided by the system 100. The information provided by the user is stored securely in an encrypted format and is used for authorizing the user while logging into the application 102. It should be appreciated that many other additional details such as captcha and more may be provided on the user interface 200 for authorizing a user.

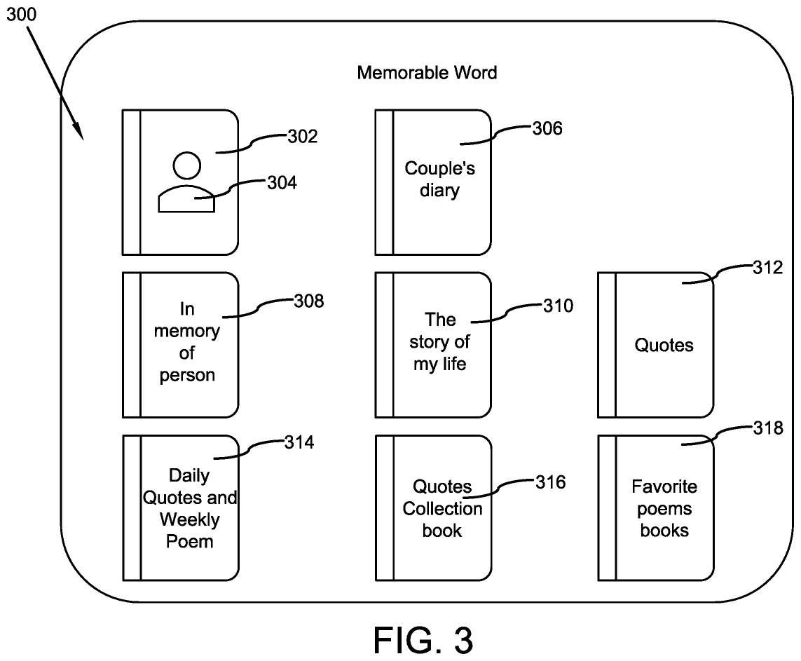

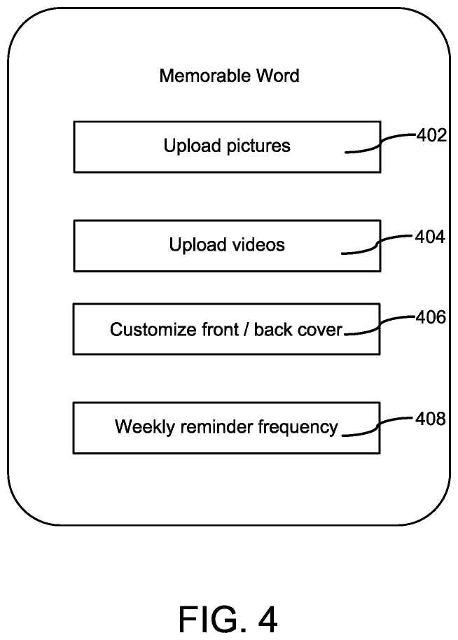

FIG. 3 illustrates another user interface of the software application showing different digital books accessible to a user in accordance with the disclosed architecture. The electronic book software application 102 enables a user to create multiple digital books for specific life events, wherein each digital book can be accessed from the software application 102. The user interface 300 of the present embodiment is configured to display different types of digital books to a user. As illustrated, a personal diary 302 includes and displays the pictures, videos, text, and other media showcasing transformation of the user over the years. The personal diary 302 enables the user to personalize the cover page 304 and the back page of the diary 302 as per the preferences of the user. As illustrated in FIG. 4, for creating and/or customizing the personal diary 302, a plurality of options such as upload pictures 402, upload videos 404, customize front/back cover 406 are provided by the software application 102. A weekly reminder frequency control 408 can be selected for enabling the application 102 to send a reminder in the form of one or more of an email, SMS, instant message, call and more to let remind the user to upload image and video for the personal diary 302.

A couple's diary 306 is configured to include personal pictures and videos uploaded by a user. When a user creates a couple's diary 306, then, a partner of the user is tagged and an email id of the partner is included. Whenever a new content or any modification is uploaded in the diary 306, then a notification is provided to the partner on the registered email id of the partner. Regular updates can be submitted by either member of the couple, therefore, acting as an interactive manner of keeping close when the couple is separated due to work commitments and more. All types of media can be included in the couple's diary 306 and real time notifications are provided to the couple.

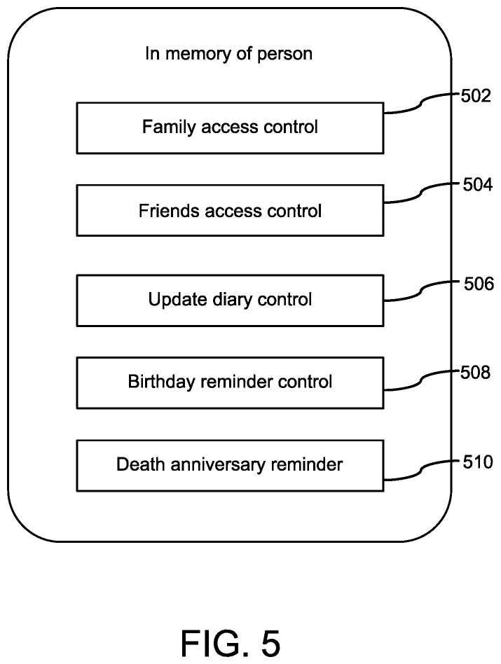

“In memory of person” diary 308 is a specific book created by a user in memory of a deceased person. The diary 308 has a customized template where each page of the diary 308 has portions for an anecdote, a funny story, an act of kindness, and more of the deceased person. For updating the diary 308, a plurality of individuals including one or more family members and one or more friends are provided access of the diary/book 308 using the family access control 502 and friends access control 504 respectively of the interface 500 as shown in FIG. 5. Update diary control 506 enables the users to update and comment on the content of the diary 308. A birthday reminder control 508 when enabled enables all the authorized users of the diary 308 to receive a notification on the birthday of the deceased person for which the diary 308 is created. Similarly, a death anniversary reminder 510 when enabled enables all the authorized users of the diary 308 to receive a notification on the death date of the deceased person.

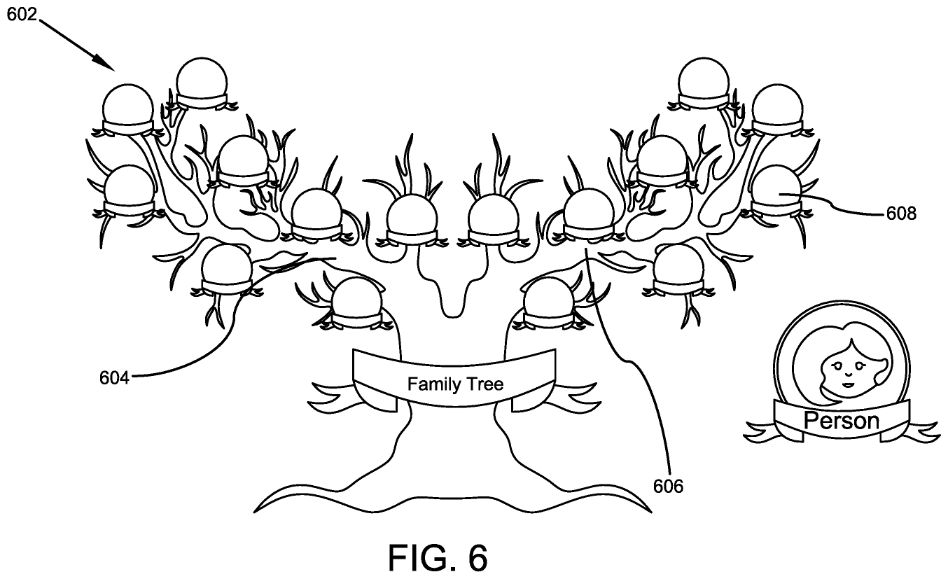

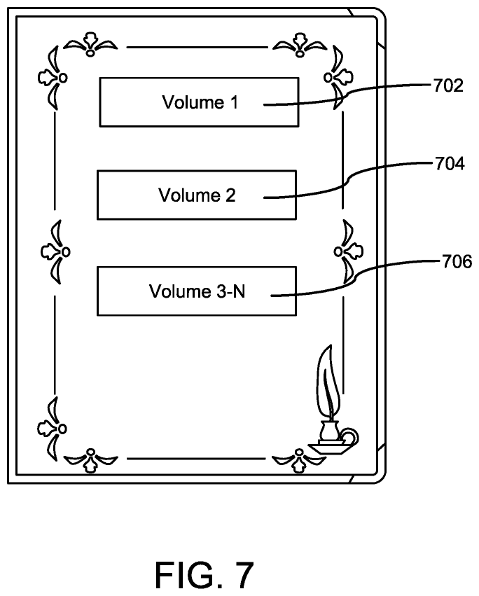

“The story of my life” book 310 is a unique book offered by the system 100 and enables a user to add details of life of a baby from conception in the form of a story. The baby can be a child of the user or any other baby in close relation of the user. The book 310 provides a template enabling a user to record a plurality of details such as, but not limited to, place and day of conception, first visit to the gynecologist, details of the pregnancy, first image and video of the sonogram, images, and videos of baby shower. The book 310 is divided into a plurality of sections or volumes as illustrated in FIG. 7 separately describing the life of the baby. The first volume 702 ends with record of baby's footprint, name of delivering doctor, size, weight, hospital, and an image of the first time the parents held the baby and picture of the baby the first day home and a family tree. The family tree 602 as illustrated in FIG. 6 has two branches 604, 606, first branch 604 representing maternal side and the second branch 606 representing the paternal side such that each leaf or family block 608 displays a family member picture of the time when the baby was born.

The second volume 704 of the book 310 contains additional details of first six months of the baby. The remaining volumes 706 of the book 310 include information about the life of the baby until the baby starts to write his/her own words/details. A user accessing the book 310 can directly jump onto a specific volume by clicking the hyperlinked volume numbers 702, 704, 706 and more.

A quotes diary 312 includes a list of famous quotes and poems. Once the user configures the diary 312 to send the quote of the day wherein the quote is automatically selected by the system 100, a voice recorded quote is transmitted to the user as an SMS, email, and more to serve as a wakeup call.

A daily quotes and weekly poem book 314 is a special book having a plurality of quotes and poems included therein. The book 314 can be configured to display and send one quote per day, a poem per week, and may provide a poet per month to the user. This is useful for individuals who like to read and listen to quotes and poems and the book 314 may be selected by a user as per preferences.

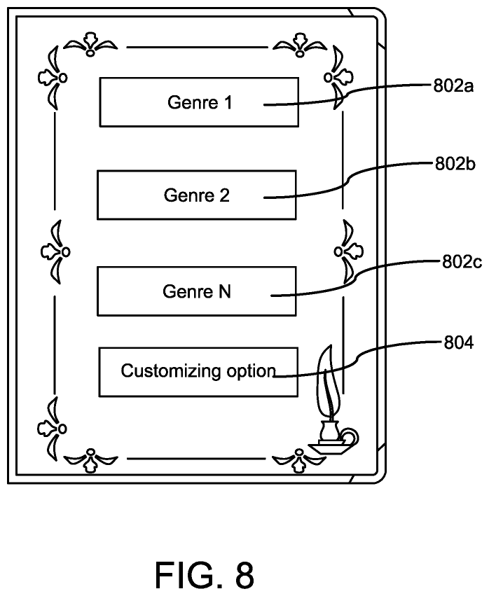

A quotes collection book 316 is configured to have a collection of more than 1000 poems. The poems are segregated by a plurality of genres 802a-n as illustrated in FIG. 8. A user can mark one or more favorite genres and can like individual poems. The poems liked by the user may be used for creating separate digital or electronic books which can be accessed by the user. Like other digital or electronic books offered by the system 100, the personalized poem books 318 can be customized by customizing the cover page, back cover, title, uploading additional poems, and more using the customizing option 804. A user can create up to three books having up to forty poems each.

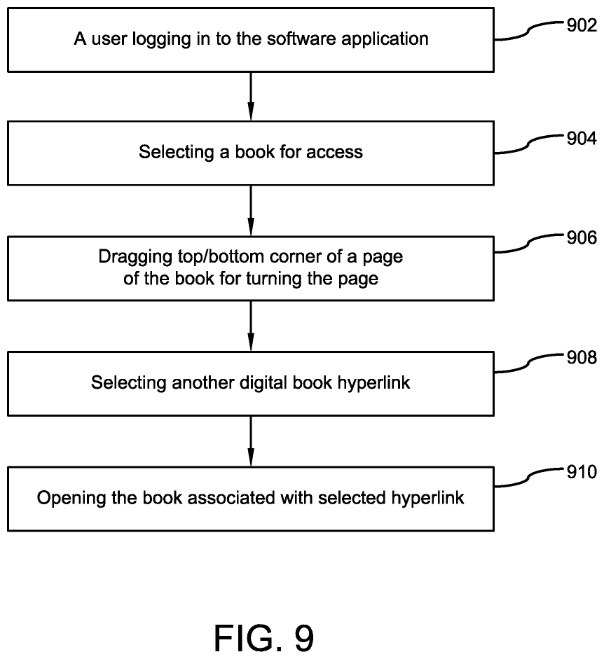

FIG. 9 illustrates a flow diagram depicting a process of accessing digital or electronic books on the software application 102 by a user in accordance with the disclosed architecture. Initially, a user login the software application using the credentials as illustrated in FIG. 2 (Step 902). Then, a digital book provided on the portal/interface of the application is selected by the user (Step 904). For turning a page to read through the selected book, the top/bottom corner of a page of the digital book is dragged by the user in a manner similar to the turning of the page of a physical book (Step 906). Alternatively, a page can be clicked to turn the page. Each book offered by the system 100 is inter-linked to similarly contextual books and the user can select a hyperlink of another digital book (Step 908). Finally, the associated or linked book is opened enabling the user to easily access the book (Step 910).

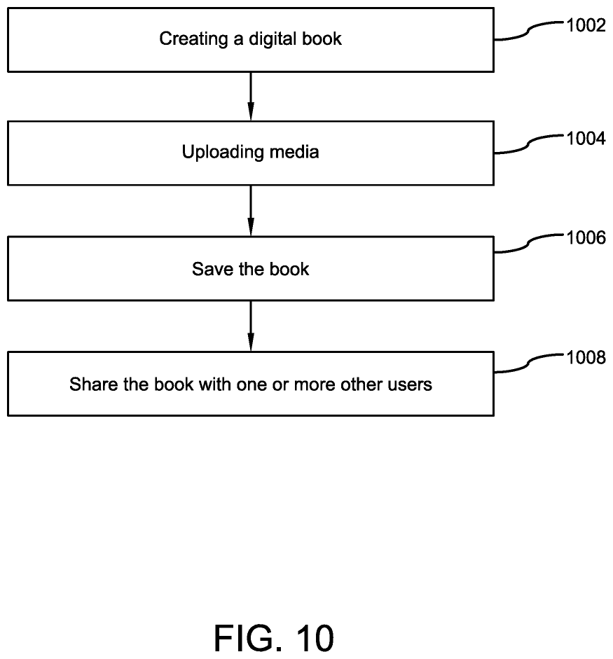

FIG. 10 illustrates a flow diagram depicting a process of creating and customizing a digital book by a user in accordance with the disclosed architecture. Initially, a user may create a digital book as per the preferences (Step 1002). Then, the user may customize the create book or one or more additional books by uploading media (Step 1004). Thereafter, the changes are saved and published by the user enabling changes to get synced with the server (Step 1006). Finally, the book may be shared with one or more users such as family members, friends and more (Step 1008).

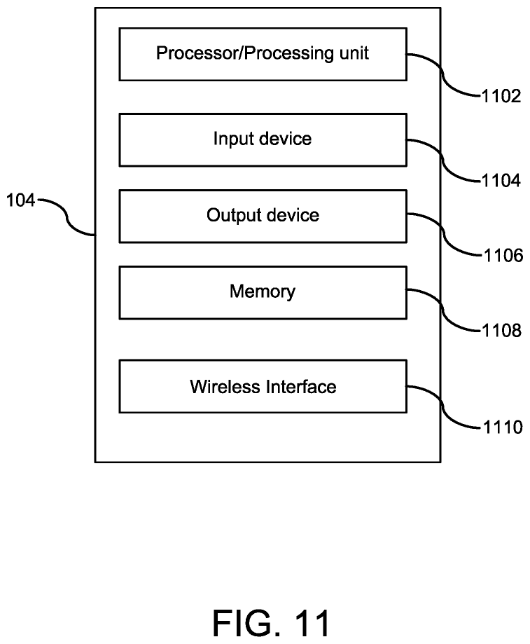

FIG. 11 illustrates an exemplary user device 104 that is used for installing the software application 102 of the present invention for communication with the server system in accordance with the disclosed architecture. The processing unit 1102 can include suitable logic, instructions, circuitry, interfaces, and/or codes for executing various operations, such as the operations associated with the user device 104, or the like. The processing unit 1102 may be configured to control one or more operations executed by the user device 104 in response to the input received at the user device 104 from the user. The processor 1102 executes the computer readable instructions stored in the application 102. Examples of the processing unit 1102 can include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 1102 including known, related art, and/or later developed processing units. The user device 104 can further include one or more computer executable applications configured to be executed by the processing unit 1102. The one or more computer executable applications can include suitable logic, instructions, and/or codes for executing various operations. The one or more computer-executable applications may be stored in the memory 1108. The one or more computer executable applications includes the application 102.

The user device 104 includes input device(s) 1104 such as a touch input device, voice input device, etc. for entering data and information. Preferably, the touch interface of the user device 104 is used as the input and various buttons/tabs shown on the application 102 are pressed or clicked by the user. The display of the user device 104 also acts as the output device 1106 for displaying various contents (e.g., text, images, videos, icons, and/or symbols, etc.) to the user. The display can include a touch screen, and may receive, for example, a touch, gesture, proximity, or hovering input using an electronic pen or a part of a user's body.

Electronic device 104 has memory 1108 used for storing programs (sequences of instructions) or data (e.g., program state information) on a temporary or permanent basis for use in the computer system. Memory 1108 can be configured for short-term storage of information as volatile memory and therefore does not retain stored contents if powered off. Examples of volatile memories include random access memories (RAM), dynamic random-access memories (DRAM), static random-access memories (SRAM), and other forms of volatile memories known in the art. The processor 1102, in combination with one or more of memory 1108, input device(s) 1104, output device(s) 1106 is utilized to provide users to execute instructions on the application 102. The connection to a network is provided by wireless interface 1110.

The wireless interface 1110 enables the user device 104 to communicate with the server and other components of the system 100 over the communication network, according to embodiments of the present disclosure. Examples of the communication interface 1110 can include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “personalized electronic books system”, “digital books system”, and “system” are interchangeable and refer to the personalized electronic books system 100 of the present invention.

Notwithstanding the forgoing, the personalized electronic books system 100 of the present invention can be of any suitable configuration as is known in the art without affecting the overall concept of the invention, provided that it accomplishes the above stated objectives. One of ordinary skill in the art will appreciate that the personalized electronic books system 100 as shown in the FIGS. are for illustrative purposes only, and that many other configurations are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personalized electronic book system comprising:
a computer-implemented software application accessed in a computing device for creating and accessing a plurality of electronic books;
wherein said plurality of electronic books correspond to different life events;
wherein said creating said plurality of electronic books having recorded user said life events;
wherein said plurality of electronic books include information selected from a group consisting of a genealogy, a story of life, a life of a deceased person, a quote, a poem, an image, and a chapter;
a user information module for storing information selected from a group consisting of user credentials, personal information, and payment information;
wherein said user information module compares credentials input by the user with said stored user credentials;
a metadata module for storing metadata items selected from a group consisting of a publication date, a timestamp, a title, a tag, and a comment;
wherein said metadata module for searching said plurality of electronic books and copying said information from one electronic book to another electronic book; and
further wherein each said electronic book having a sequence of said chapters associated with a metadata for adjusting, copying, and changing said chapters.

2. The personalized electronic book system of claim 1, wherein said computer implemented software application stores said plurality of electronic books.

3. The personalized electronic book system of claim 2, wherein said storing said plurality of electronic books having a remote server accessible through a network.

4. The personalized electronic book system of claim 3, wherein said remote server having a user interface module for accessing said plurality of electronic books.

5. The personalized electronic book system of claim 4, wherein said user interface module for creating said plurality of electronic books.

6. The personalized electronic book system of claim 5, wherein said plurality of electronic books imitate physical books in appearance.

7. The personalized electronic book system of claim 5 further comprising an e-book module for modifying the layout of said plurality of electronic books.

8. The personalized electronic book system of claim 7, wherein said e-book module provides information selected from a group consisting of a textual portion and a graphical portion.

9. The personalized electronic book system of claim 8, wherein said computing device is a smartphone.

10. The personalized electronic book system of claim 9 further comprising a user interface module having an editor for defining and uploading new content.

11. The personalized electronic book system of claim 10, wherein said computer implemented software application having a fee.

12. The personalized electronic book system of claim 11, wherein said server is selected from a group consisting of a personal computer, a laptop, a mini-computer, a mainframe computer.

13. A personalized electronic book system comprising:
a computer implemented software application accessed in a computing device for creating and accessing a plurality of electronic books;
wherein said plurality of electronic books correspond to different life events;
wherein said creating said plurality of electronic books having recorded user said life events;
wherein said plurality of electronic books include information selected from a group consisting of a genealogy, a story of life, a life of a deceased person, a quote, a poem, an image, and a chapter;
a user information module for storing information selected from a group consisting of user credentials, personal information, and payment information;
wherein said user information module compares credentials input by the user with said stored user credentials;
a metadata module for storing metadata items selected from a group consisting of a publication date, a timestamp, a title, a tag, and a comment;
wherein said metadata module for searching said plurality of electronic books and copying said information from one electronic book to another electronic book;
wherein each of said plurality of electronic books having a sequence of said chapters associated with a metadata for adjusting, copying, and changing said chapters;
a sign-up option having a profile including personal information for accessing said computer implemented software application; and
further wherein said plurality of electronic books imitate physical books in appearance.

14. The personalized electronic book system of claim 13, wherein said electronic book having a personal diary including personal information selected from a group consisting of a picture, a video, and a text.

15. The personalized electronic book system of claim 14 further comprising a user interface module having an editor for defining and uploading new content to said personal diary.

16. The personalized electronic book system of claim 15, wherein said editor having options to upload said picture and said video.

17. A personalized electronic book system comprising:
a computer-implemented software application accessed in a computing device for creating and accessing a plurality of electronic books;
wherein said plurality of electronic books correspond to different life events;
wherein said creating said plurality of electronic books having recorded user said life events;
wherein said plurality of electronic books include information selected from a group consisting of a genealogy, a story of life, a life of a deceased person, a quote, a poem, an image, and a chapter;
a user information module for storing information selected from a group consisting of user credentials, personal information, and payment information;
wherein said user information module compares credentials input by the user with said stored user credentials;
a metadata module for storing metadata items selected from a group consisting of a publication date, a timestamp, a title, a tag, and a comment;
wherein said metadata module for searching said plurality of electronic books and copying said information from one electronic book to another electronic book;
wherein each of said plurality of electronic books having a sequence of said chapters associated with a metadata for adjusting, copying, and changing said chapters;
a sign-up option having a profile including personal information for accessing said computer-implemented software application;
wherein said plurality of electronic books having a first personal diary and a second personal diary each including personal information selected from a group consisting of a picture, a video, and a text; and
further wherein said first personal diary and said second personal diary linked as a couple's diary.

18. The personalized electronic book system of claim 17 further comprising a user interface module having an editor for defining and uploading new content to said couple's diary.

19. The personalized electronic book system of claim 18 further comprising a notification from said first personal diary to said second personal diary upon said uploading new content to said couple's diary.

20. The personalized electronic book system of claim 17, wherein at least one of said first personal diary and said second personal diary is a deceased person diary.
